(19) United States
(12) Patent Application Publication
(10) Pub. No.: US 2014/0347188 A1
(43) Pub. Date: Nov. 27, 2014

(54) AUTO-ADJUST OF INDICATION CHARACTERISTICS BASED ON USER PROXIMITY

(71) Applicant: MOTOROLA MOBILITY LLC, Libertyville, IL (US)

(72) Inventors: Rachid M. Alameh, Crystal Lake, IL (US); Paul R. Steuer, Hawthorn Woods, IL (US); Jason P. Wojack, Libertyville, IL (US)

(73) Assignee: MOTOROLA MOBILITY LLC, Libertyville, IL (US)

(21) Appl. No.: 13/949,263

(22) Filed: Jul. 24, 2013

Related U.S. Application Data
(60) Provisional application No. 61/826,072, filed on May 22, 2013.

(51) Int. Cl. G08B 21/18

(52) U.S. Cl. CPC G08B 21/182
USPC 340/686.6

(57) ABSTRACT

Disclosed are a system and method whereby indications of an event such as an incoming text message or phone call are provided to a mobile device user in a manner, and to an extent, that allows user awareness when practicable, while also conserving battery power. The system and method determine certain parameters with respect to the user, such as user presence or current proximity, frequency of user proximity, and other factors in order to determine whether and how to provide an indication to the user.

### CROSS-REFERENCE TO RELATED APPLICATIONS

The present application claims priority to U.S. Provisional Patent Application 61/826,072, filed on May 22, 2013, which is incorporated herein by reference in its entirety.

### TECHNICAL FIELD

The present disclosure is related generally to electronic device user indications and, more particularly, to a system and method for adjusting user indication characteristics with respect to an electronic communication device based on the proximity of a device user.

### BACKGROUND

Portable communication, entertainment, and computing devices such as cellular telephones, tablet computers, and so on have existed for quite some time, yet their capabilities continue to expand to this day. More efficient use of the wireless spectrum and the continued miniaturization of electronic components have yielded hand-held devices that can act as stand-alone computers, network nodes, personal digital assistants, and telephones.

However, every action of a mobile electronic device consumes a certain amount of electrical power, and the electrical power for most such devices is provided by a rechargeable battery. The useful life of the charged battery in a mobile device is thus limited and depends to a large extent on the actions taken by the device with respect to processing, display, and communications.

The discussion of any problem or solution in this Background section simply represents an observation of the inventors and is not to be taken as an indication that the problem or solution represents known prior art. The present disclosure is directed to a method and system that may exhibit numerous distinctions over prior systems. However, it should be appreciated that any such distinction is not a limitation on the scope of the disclosed principles or of the attached claims except to the extent expressly noted in the claims.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a generalized schematic of an example device within which the presently disclosed techniques may be implemented;

FIG. 2 is a simplified plan view of a representative environment in which the presently disclosed techniques may be practiced;

FIG. 3 is a plot showing the relative perceptibility of a ring when altered as described herein as a function of user distance from a device implementing the described techniques;

FIG. 4 is a plot showing the relative perceptibility of alert notifications when altered as described herein as a function of user distance from a device implementing the described techniques; and

FIG. 5 is a flowchart of a representative method for altering one or more characteristics of a ring or notification as a function of user proximity in accordance with an embodiment of the disclosed principles.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein. As used herein, the term “mobile electronic device” refers to a portable battery-powered device used at least in part to provide telecommunications services or notifications to a user.

As noted above, mobile electronic devices may be used to provide phone service to a user. As part of this function, the device is typically dialable to initiate an outgoing call and also has an alert function to alert the user of an incoming call. The alert function may be settable to provide an audio alert, a tactile alert (e.g., a vibration), or a combination of the two. With respect to the audio alert, also referred to as a ring, the ring is typically set to occur at a particular volume level and to repeat a predetermined number of times before stopping. Regardless, when the alert stops without the call having been answered by the user, the caller may be connected to a voice-mail function to leave a message for the user.

Similarly, a mobile electronic device may provide a notification function to a user. Such a function may notify the user regarding any number of occurrences, e.g., the receipt of a text message, the start time for a calendared event, and so on. The inventors have observed that some such alerts can be provided in the form of an animation or graphic provided on the device display for the user to see.

With respect to both audio alerts and visual notifications (herein collectively “indications”), these functions may consume a significant amount of power from the device's rechargeable battery. This will, in turn, shorten the device's useful life before the next charge, especially when such indications occur frequently. However, it is not desirable to simply prevent all such indications since doing so would greatly inconvenience the user. At the same time, any such indications that are given but that are not perceivable by the user represent a waste of battery power.

As such, the inventors have provided a mechanism and system whereby indications are provided in a manner, and to an extent, that allows user awareness when possible, while also conserving battery power when possible. In overview, the system determines certain parameters with respect to the user, such as user presence or current proximity, frequency of user proximity, and other factors to make a decision as to whether and how to provide an indication.

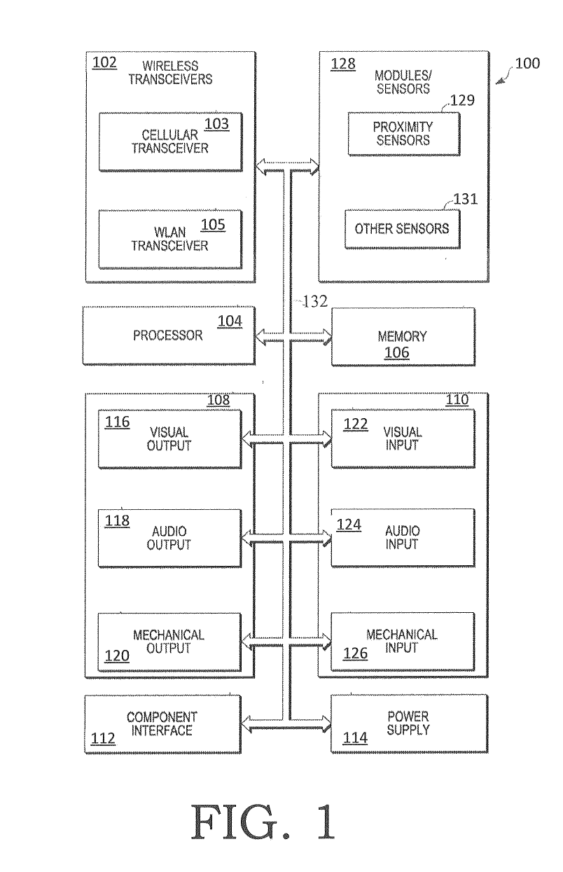

An exemplary device within which aspects of the present disclosure may be implemented is shown schematically in FIG. 1. In particular, the schematic diagram 100 illustrates exemplary internal components of a mobile smart phone implementation of a small touch-screen device. These components can include wireless transceivers 102, a processor 104, a memory 106, one or more output components 108, one or more input components 110, and one or more sensors 128. The processor 104 may be any of a microprocessor, microcomputer, application-specific integrated circuit, or the like. Similarly, the memory 106 may, but need not, reside on the same integrated circuit as the processor 104.

The device can also include a component interface 112 to provide a direct connection to auxiliary components or accessories for additional or enhanced functionality and a power supply 114, such as a battery, for providing power to the device components. All or some of the internal components may be coupled to each other, and may be in communication with one another, by way of one or more internal communication links 132, such as an internal bus.

The memory 106 can encompass one or more memory devices of any of a variety of forms, such as read-only memory, random-access memory, static random-access memory, dynamic random-access memory, etc., and may be used by the processor 104 to store and retrieve data. The data that are stored by the memory 106 can include one or more operating systems or applications as well as informational data. Each operating system is implemented via executable instructions stored in a storage medium in the device that controls basic functions of the electronic device, such as interaction among the various internal components, communication with external devices via the wireless transceivers 102 or the component interface 112, and storage and retrieval of applications and data to and from the memory 106.

With respect to programs, sometimes also referred to as applications, each program is implemented via executable code that utilizes the operating system to provide more specific functionality, such as file-system service and handling of protected and unprotected data stored in the memory 106. Although many such programs govern standard or required functionality of the small touch-screen device, in many cases the programs include applications governing optional or specialized functionality, which can be provided in some cases by third-party vendors unrelated to the device manufacturer.

Finally, with respect to informational data, this non-executable code or information can be referenced, manipulated, or written by an operating system or program for performing functions of the device. Such informational data can include, for example, data that are preprogrammed into the device during manufacture or any of a variety of types of information that are uploaded to, downloaded from, or otherwise accessed at servers or other devices with which the device is in communication during its ongoing operation.

The device can be programmed such that the processor 104 and memory 106 interact with the other components of the device to perform a variety of functions, including interaction with the touch-detecting surface to receive signals indicative of gestures therefrom, evaluation of these signals to identify various gestures, and control of the device in the manners described below. The processor 104 may include various modules and may execute programs for initiating different activities such as launching an application, data-transfer functions, and the toggling through various graphical user interface objects (e.g., toggling through various icons that are linked to executable applications).

The wireless transceivers 102 can include, for example as shown, both a cellular transceiver 103 and a wireless local area network transceiver 105. Each of the wireless transceivers 102 utilizes a wireless technology for communication, such as cellular-based communication technologies including analog communications, digital communications, next generation communications and variants thereof, peer-to-peer or ad hoc communication technologies, or other wireless communication technologies.

Exemplary operation of the wireless transceivers 102 in conjunction with other internal components of the device can take a variety of forms and can include, for example, operations in which, upon reception of wireless signals, the internal components detect communication signals and one of the transceivers 102 demodulates the communication signals to recover incoming information, such as voice or data, transmitted by the wireless signals. After receiving the incoming information from the transceivers 102, the processor 104 formats the incoming information for the one or more output components 108. Likewise, for transmission of wireless signals, the processor 104 formats outgoing information, which may or may not be activated by the input components 110, and conveys the outgoing information to one or more of the wireless transceivers 102 for modulation as communication signals. The wireless transceivers 102 convey the modulated signals to a remote device, such as a cell tower or an access point (not shown).

The output components 108 can include a variety of visual, audio, or mechanical outputs. For example, the output components 108 can include one or more visual-output components 116 such as a display screen. One or more audio-output components 118 can include a speaker, alarm, or buzzer, and one or more mechanical-output components 120 can include a vibrating mechanism for example. Similarly, the input components 110 can include one or more visual-input components 122 such as an optical sensor or a camera, one or more audio-input components 124 such as a microphone, and one or more mechanical-input components 126 such as a touch-detecting surface and a keypad.

The sensors 128 can include both proximity sensors 129 and other sensors 131, such as an accelerometer, a gyroscope, any haptic, light, temperature, biological, chemical, or humidity sensor, or any other sensor that can provide pertinent information, such as to identify a current location of the device.

Actions that can actuate one or more input components 110 can include, for example, powering on, opening, unlocking, moving, or operating the device. For example, upon power on, a “home screen” with a predetermined set of application icons can be displayed on the touch screen.

As noted above, a user may configure such a mobile electronic device to ring a fixed number of times at a particular loudness level to indicate an incoming call. However, in addition to sometimes being wasteful, these fixed settings may be inadequate if the user is far from the device and may be jarring if the user is close to the device. Similarly, a visual notification regarding an incoming text message or a calendar event may be useful when the user is at the device in a normally lit room, but such notifications may be wasteful when the user is away from the device, may be difficult to see when the user is in the room but not at the device, and may be annoying if the user is at the device in a darkened room such as a theater.

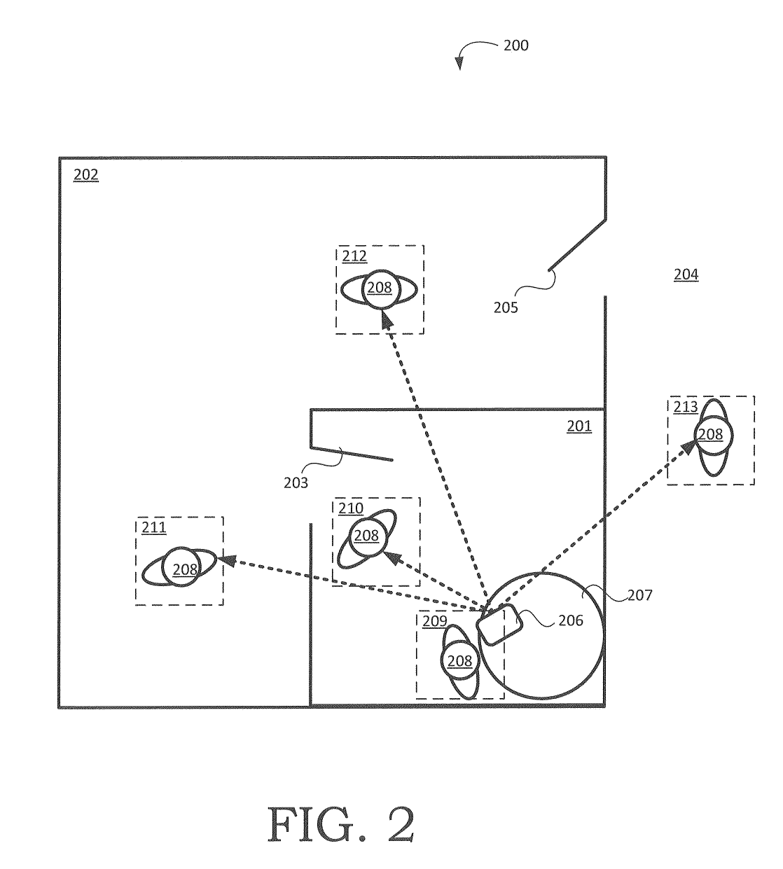

In an embodiment, the mobile electronic device is configured to adaptively adjust the characteristics of an indication based on user presence or proximity with respect to the device. A typical physical environment within which the described system may be implemented is shown schematically in FIG. 2.

In the illustrated example, the simplified building structure 200 includes a room 201 separated from a main living space 202 by a first door 203. The interior of the building structure 200 is separated from the outdoors 204 by a second door 205. Within the room 201, a mobile electronic device 206 rests on a table 207.

A user 208 may be situated in any of the above locations, but in the illustrated example it is assumed that the mobile electronic device 206 remains on the table 207. In a first scenario, the user 208 inhabits a first location 209, located at the table 207, and is in contact with the mobile electronic device 206. In a second scenario, the user 208 inhabits a second location 210 that is located in the room 201 but not as near to the mobile electronic device 206. In a third scenario, the user 208 inhabits a third location 211 that is located within the main living space 202 close to the first door 203, and in a fourth scenario, the user 208 inhabits a fourth location 212 that is located within the main living space 202 farther from the first door 203. Finally, in a fifth scenario, the user 208 inhabits a fifth location 213 that is located in the outdoor space 204. It will be appreciated that although the above locations are given as examples, the user 208 may be located at many other analogous locations such as on another floor of a structure, in a bathroom of the structure, in a garage associated with a structure, and so on.

In each scenario, the mobile computing device 206 is configured to alter the characteristics of upcoming indications based on information detected or inferred regarding the user's location and the environment. For example, if the user 208 is located in location 209, next to the table 207, close to or in contact with the mobile computing device 206, then the mobile computing device 206 may alter incoming indications to reflect the closeness and presumed attentiveness of the user. The mobile computing device 206 may determine that the user 208 is close to or touching the mobile computing device 206 via a touch sensor, e.g., on the back of the mobile computing device 206, via sensing a user operation such as a key touch, via a thermal sensor, or via any other suitable mechanism.

In one aspect, in this scenario the mobile computing device 206 may turn the device ringer off and employ a vibratory ring or a screen-based ring such as a brightening of the screen, a listing of a calling number, or other low volume or inaudible ring techniques if the user 208 is touching the device. If the user 208 is close to but not touching the device, then the device may provide one ring at low or minimum loudness.

With respect to incoming notifications, e.g., due to text messages or to calendar events, the mobile computing device 206 may, in this scenario, display an animated notification of normal brightness notifying the user 208 of the event in question. In this way, the ring and notification characteristics are altered to the extent needed in recognition of the close user proximity to minimize user annoyance and unnecessary energy expenditure.

In another example, if the user 208 is located in the second location 210, that is, located in the room 201, but not at the mobile electronic device 206, then the mobile computing device 206 may alter incoming indications to reflect the proximal location and reduced attentiveness of the user 208. The mobile computing device 206 may determine that the user 208 is located in the room 201 but not near to the mobile electronic device 206 via direct measurement, e.g., using a thermal sensor, or via inference from various detected environmental factors. For example, the mobile computing device 206 may detect an increase in brightness when a user 208 enters the room 201 and switches the lights on or may detect miscellaneous user sounds such as coughing, breathing, talking, scuffing of shoes, and so on.

When user-proximity indicators are detected but the user 208 cannot be directly detected at the mobile computing device 206, the mobile computing device 206 may then infer that the user 208 is in the room 201 but not at the mobile computing device 206. In addition, a thermopile or heat sensor may be used to judge the user's distance from the device 206.

Continuing in this scenario, the mobile computing device 206 may turn the device ringer on to ring once at a reduced volume. In this way, the ring is audible to the user 208 but will stop after one ring in recognition of the fact that the user 208, though proximate, has chosen not to answer. The mobile computing device 206 may detect user distance from the device via a gyro-motion sensor or thermopile heat sensor for example.

With respect to incoming notifications, the mobile computing device 206 may alter the notification characteristics based on the user's approximate distance from the device 206. For example, if the user 208 is within viewing distance of the device 206, as determined for example by a body-heat sensor, then an animated and bright notification is given. If the user 208 is farther away, then the animation may be magnified for better visibility, e.g., with larger icons, brighter colors, slower animation speeds, etc. If the user 208 is in the room but out of visual range for seeing a detailed animated notification, an audible notification may be enabled instead to most effectively alert the user 208.

In another example, if the user 208 is located in the third location 211 or the fourth location 212, that is, in the building but outside the room 201, then the mobile computing device 206 may alter incoming indications to reflect the user's presumably reduced perception of the device sounds and the inability to observe the device screen. The mobile computing device 206 may determine that the user 208 is located outside the room 201 but inside the building structure 200 via inference.

For example, there may be no constant indication of a presence in the room 201 with the mobile computing device 206, but the user 208 may periodically be detected in the room 201 or at the mobile computing device 206 itself. In this case, the mobile computing device 206 may infer that the user 208 is within the building structure 200 whenever the user 208 is not detected or inferred to be in the room 201. In this scenario, the mobile computing device 206 may configure the device ringer to ring (1) more times at the user-set volume, (2) fewer times a higher volume, or (3) more times and at a higher volume than the user 208 has set.

With respect to incoming notifications, the mobile computing device 206 may, in this scenario, provide no visual or audible notification but instead defer notification until the user 208 is again present. In this way, the energy that would be used in displaying an animated notification, powering a blinking light, or emitting a tone is saved in recognition of the fact that the user 208 presumably cannot observe or hear the device 206 from the third location 211 or from the fourth location 212.

In a final example, consider the case where the user 208 is located in the fifth location 213, i.e., in the outdoor space 204 outside the building 202 (or further away at another outdoor location or within another building). The mobile computing device 206 may determine that the user 208 is located in the outdoor space 204 outside the building 202 via inference. For example, if a predetermined period of time, e.g., one hour, passes with no detected or inferred presence of the user 208 in the room 201 with the mobile computing device 206 and no interaction by the user 208 with the mobile computing device 206, then the mobile computing device 206 may infer that the user is located in the outdoor space 204.

In this example, the mobile computing device 206 may alter incoming indications to reflect the fact that the user 208 can presumably neither hear nor observe the mobile computing device 206. Thus, in this scenario, the mobile computing device 206 may turn the device ringer off and may provide no visual or audible notifications at all. In this way, the energy that would normally be used in providing an audible ring or displaying an animated notification or a blinking light is saved in recognition of the fact that the user 208 cannot observe the device from the fifth location 213.

As noted above, there are scenarios when a notification that might otherwise be given is deferred based on lack of user presence. In each such scenario, when the user's presence in the room 201 is again subsequently detected, the mobile computing device 206 is configured, in an embodiment, to provide appropriate notifications based on the user's distance from the device 206.

With respect to inferring the user's location, the mobile computing device 206 may employ predictive inference in an embodiment of the disclosed principles. For example, the mobile computing device 206 may track the user's past presence or past interactions with the device 206 to infer that the user 208 may be present at certain times even though the user 208 has not been determined to be present recently. For example, suppose the user 208 shows a pattern of being present between 6:00 p.m. and 9:00 p.m. every weekday evening. If an indicatable event occurs at 7:00 pm on a subsequent Thursday during which no user presence has been detected, then the mobile computing device 206 may infer that the user 208 is within the building structure 200.

Similarly, the mobile computing device 206 may infer user presence or absence based on schedule or meeting data accessible to the device. For example, the mobile computing device 206 may infer from a listing of an out-of-town meeting on the user's calendar that the user 208 is out of town. Similarly, based on meeting requests and other emails mentioning times and places, the mobile computing device 206 may determine that the user 208 is elsewhere at a particular time.

In an alternate embodiment, if user presence is not detected near the device 206 during an incoming call, then the caller may be automatically alerted of the user's absence so that he may, for example, decide to hang up the call rather than wait for an answer. Alternatively, the call may be switched to voicemail without waiting through a ring sequence in such a situation.

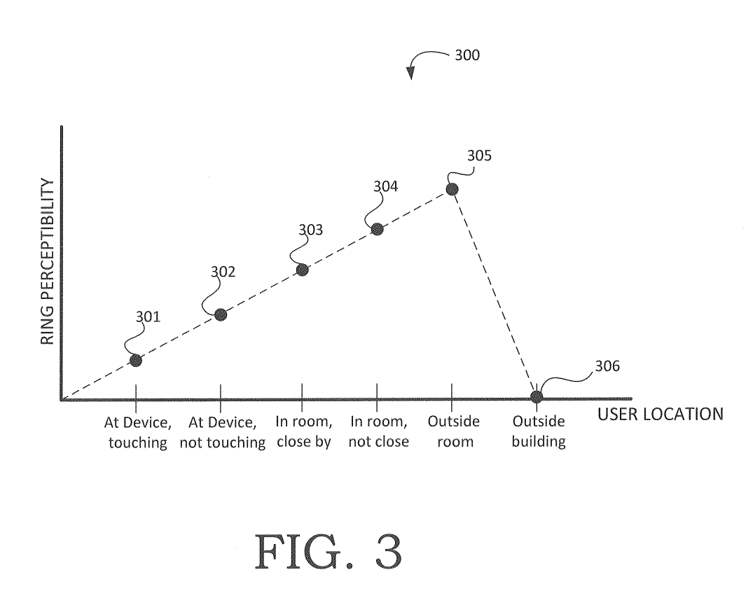

As noted above, the characteristics of the ring of the mobile computing device 206 are altered in response to the detected or inferred user distance from the device 206. FIG. 3 shows a plot 300 of the ring perceptibility versus the detected or inferred user proximity in accordance with an embodiment of the disclosed principles. It will be appreciated that plotted values are meant to show relative perceptibility only and not a linear, nonlinear, proportional, or other relationship between perceptibility and distance. In this example, the ring perceptibility is reflected in an intended perceptibility based on the ring volume and repetition number, not a subjective measure of actual perceptibility by the user 208.

As can be seen, the perceptibility of the ring, as altered by the mobile electronic device 206, generally increases with the user's detected or inferred distance from the device (that is, when the user 208 is at one of positions 301, 302, 303, 304, and 305). When the detected or inferred user position is outside the structure, however (that is, at position 306 or the like), the perceptibility goes to zero. In this way, the device 206 balances user access, user annoyance, and battery-power conservation concerns to reach the user 208 when possible (and when determined to be desirable) and to otherwise conserve battery power.

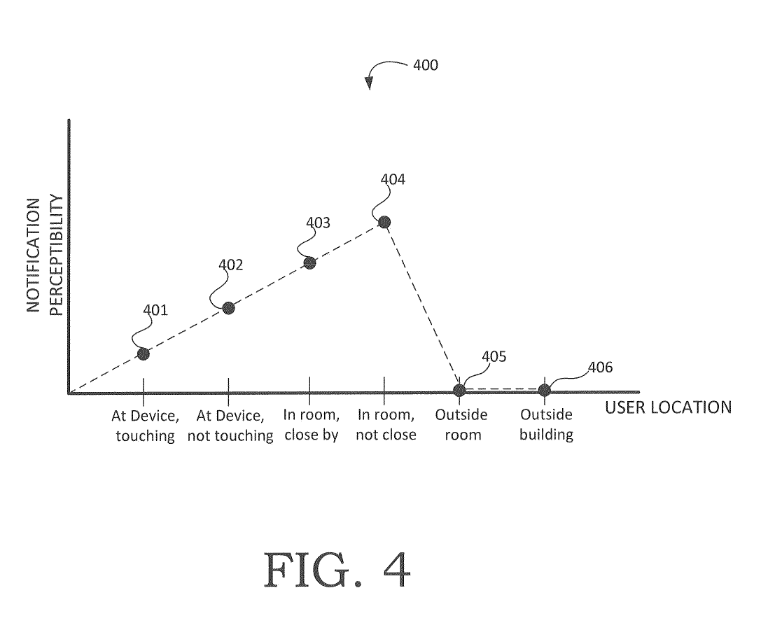

Similarly, it was noted earlier that the characteristics of the notifications given by the mobile computing device 206 are also altered in response to the detected or inferred user distance from the device 206. FIG. 4 shows a perceptibility plot 400 in this regard, plotting the notification perceptibility versus the detected or inferred user proximity in accordance with an embodiment of the disclosed principles. In this example, the notification perceptibility is reflected in the notification type (blinking light, animated display, or audible alert). As with the perceptibility of the device ring, the illustrated perceptibility of device notifications is meant to show relative perceptibility only and not specific magnitudes or any specific numerical relationships between perceptibility and distance.

At any rate, as with the perceptibility of device rings, the perceptibility of the device notifications, as altered by the mobile electronic device 206, initially increases with the user's detected or inferred distance from the device 206 (that is, when the user 208 is at one of positions 401, 402, 403, and 404). However, when the detected or inferred user position is outside the room hosting the device (that is, when the user is at one of positions 405 and 406 or the like), the perceptibility goes to zero. In this way, the device 206 again balances user access, user annoyance, and battery-power conservation concerns to alert the user 208 of incoming messages when possible and to otherwise conserve battery power. As noted above, deferred notifications may be provided to the user 208 when the user's presence is next detected or inferred.

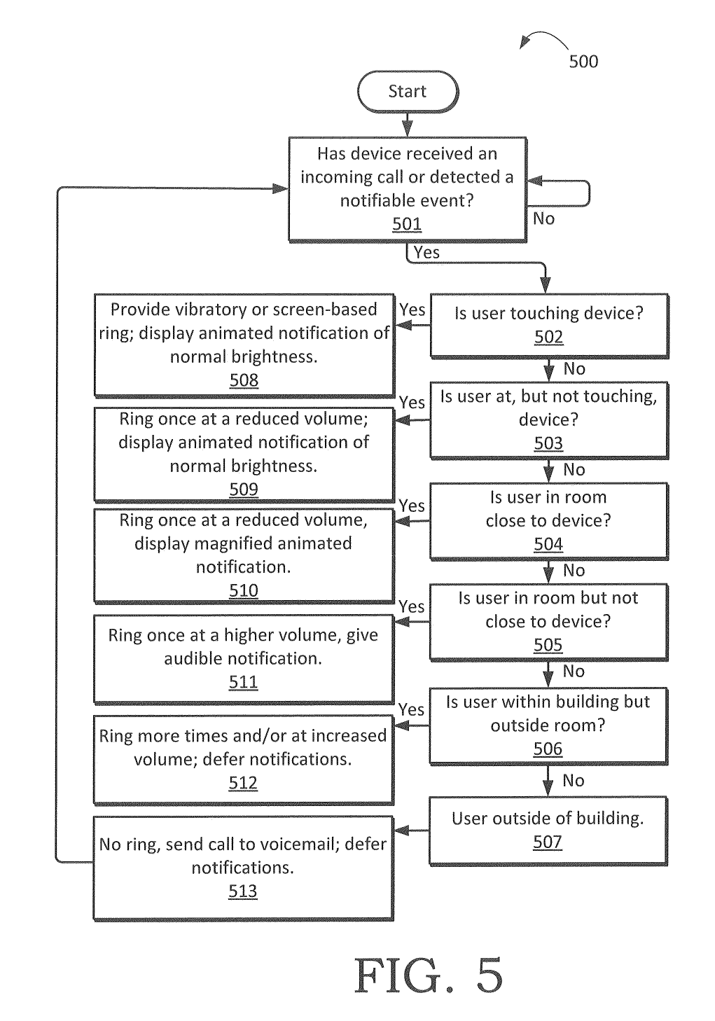

A computerized process for altering ring and notification characteristics, as well as associated actions, based on user proximity is shown in the flow chart 500 of FIG. 5. It will be appreciated that the illustrated process is undertaken in an automatic fashion by the mobile computing device 206. In this regard, the device executes computer-executable instructions read from a nontransitory computer-readable medium such as a random-access memory, read-only memory, flash memory, optical memory, magnetic memory, and so on.

In overview, the process 500 entails navigating a decision tree to determine appropriate characteristics for device ringing and device notifications. It will be appreciated, however, that the indication modification process may be carried out differently without departing from the scope of the described principles. For example, the device could instead make an initial determination that the indicatable event is a ring, and then only take steps related to the ring characteristics, and so on.

In keeping with the disclosed principles, the example process 500 begins at stage 501, wherein the mobile computing device 206 determines whether the device 206 has received an incoming call or detected a notifiable event. If either is true, then the process flows to stage 502 wherein the device 206 determines whether the user 208 is touching the device 206. If so, then the process flows to stage 508 and provides a vibratory or screen-based ring (if the indicatable event is an incoming call) or an animated notification display of normal brightness (if the indicatable event is a notifiable event). Otherwise, the process 500 flows to stage 503.

At stage 503, the device 206 determines whether the user 208 is at the device 206 but not touching it. If so, then the process flows to stage 509 and provides one ring at reduced volume (if the indicatable event is an incoming call) or an animated notification display of normal brightness (if the indicatable event is a notifiable event). Otherwise, the process 500 flows to stage 504, wherein the device 206 determines whether the user 208 is in the room close to the device 206. If so, then the process flows to stage 510 and rings once at a reduced volume (if the indicatable event is an incoming call) or provides a magnified animated notification display (if the indicatable event is a notifiable event). Otherwise, the process 500 flows to stage 505.

At stage 505, the device 206 determines whether the user 208 is in the room but not near the device 206. If this is the case, then the process flows to stage 511, wherein the device 206 rings once at a higher volume (if the indicatable event is an incoming call) or provides only an audible notification (if the indicatable event is a notifiable event). Otherwise, the process 500 flows to stage 506. At stage 506, the device 206 determines whether the user 208 is out of the immediate room but still within the larger structure, and if this is true, then the process flows to stage 512. At stage 512, the device 206 provides a ring of increased volume or repetition (if the indicatable event is an incoming call). If the indicatable event is n notifiable event, then the device 206 defers the associated notification until the user 208 is again present in the room. Otherwise, the process 500 flows to stage 507.

If the user 208 is outside of the building as determined by the device 206 at stage 507, then the process flows to stage 513. Otherwise the process 500 returns to stage 501 to await a further indication of an indicatable event. At stage 513, the device provides no ring and may send the incoming call to voice or defer the associated notification until the user 208 is again present (if the indicatable event is a notifiable event).

Although the foregoing discussion focuses on configuring rings and alerts in recognition of user proximity, it will be appreciated that other factors may additionally or alternatively be used to modify indication characteristics. For example, as noted above, it may be annoying or inconvenient for a user to be subjected to a bright on-screen notification in certain situations, such as when the user is in a darkened environment, e.g., in a slide-driven meeting, in the theater, in a darkened laboratory or collaboration space, etc.

As such, in an embodiment, the mobile computing device is configured to detect a lack of ambient light, e.g., via a photo sensor or otherwise, and to modify characteristics of notifications to provide an improved user experience in such circumstances. In particular, the device may reconfigure notification characteristics so as to minimize the visual intrusion of the notification by eliminating visual characteristics and instead providing a vibratory or reduced volume audible notification. Alternatively, the device may still provide a screen display notification but at a reduced brightness level.

It will appreciated that the disclosed principles provide a novel way of optimizing user access and convenience during the use of a mobile computing device while also optimizing device battery life when possible. In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

We claim:

1. A method of providing a user indication of an event from a mobile computing device to a user of the mobile computing device, the user indication having one or more characteristics, the method comprising:
receiving an indication at the mobile computing device that the event has occurred;
determining a proximity of the user to the mobile computing device;
generating the user indication of the event at the mobile device, including selecting the one or more characteristics of the user indication based on the determined proximity of the user to the mobile computing device; and
providing the user indication from the mobile computing device to the user.

2. The method of claim 1 wherein receiving an indication at the mobile computing device that an event has occurred comprises receiving an indication of an incoming call.

3. The method of claim 2 wherein the one or more characteristics of the indication include one or both of a ring volume and a ring-repetition number.

4. The method of claim 1 wherein receiving an indication at the mobile computing device that an event has occurred comprises receiving an indication of one of an incoming text message and a calendar event.

5. The method of claim 4 wherein the characteristics of the indication include a brightness of an animated display, a magnification of the animated display, an animation speed of the animated display, and an audible alert.

6. The method of claim 1 wherein determining a proximity of the user to the mobile computing device comprises detecting one or more of a user touch of the device, a user-generated sound, and an ambient light characteristic.

7. The method of claim 1 wherein determining a proximity of the user to the mobile computing device comprises inferring user location based on past user behavior.

8. The method of claim 1 wherein determining a proximity of the user to the mobile computing device comprises inferring user location based on user data accessible to the mobile computing device wherein the user data indicate a scheduled user activity.

9. The method of claim 2:
wherein determining a proximity of the user comprises determining that the proximity of the user renders the user unavailable;
the method further comprising informing a caller associated with the incoming call that the user is not available rather than playing a ring to the caller.

10. The method of claim 2:
wherein determining a proximity of the user comprises determining that the proximity of the user renders the user unavailable;
the method further comprising sending the incoming call to voicemail rather than playing a ring to the caller.

11. The method of claim 4:
wherein determining a proximity of the user comprises determining that the proximity of the user renders the user unavailable;
the method further comprising deferring any notification associated with one of an incoming text message and a calendar event.

12. A method of configuring indications from a mobile device to a user based on a proximity of the user to the mobile device, the method comprising:
determining the proximity of the user to the mobile device; and
withholding one or more indications when the proximity of the user indicates that the user is unavailable and otherwise providing one or more indications in a manner determined based on the proximity of the user to the mobile device.

13. The method of claim 12 further comprising determining that the proximity of the user to the mobile device indicates that user is present and providing to the user an indication that was previously deferred.

14. The method of claim 12 wherein the one or more indications include an indication of an incoming call.

15. The method of claim 12 wherein the one or more indications include an indication of a calendar event.

16. The method of claim 12 wherein the one or more indications include an indication of an incoming text message.

17. A mobile electronic device for indicating an event to a user of the device, the device comprising:
a display screen;
an audible-alert component; and
a processor configured to determine a condition of the user relative to the mobile device, the condition including at least one of a user proximity, a user touch, and an ambient-light level, and to provide an indication regarding the event to the user via the display screen or the audible-alert component, the indication having at least one characteristic that is selected based on the determined user condition.

18. The mobile electronic device of claim 17 wherein the processor is further configured to determine a condition of the user by detecting a location of the user relative to the mobile device.

19. The mobile electronic device of claim 17 wherein the processor is further configured to determine a condition of the user by inferring a location of the user relative to the mobile device based on one or more of a sound detected at the mobile device, a light level detected at the mobile device, and a light-level change detected at the mobile device.

20. The mobile electronic device of claim 17 wherein the processor is further configured to provide only a vibratory indication if the condition of the user indicates that the user is touching the device.
